(19) United States
(12) Patent Application Publication
(10) Pub. No.: US 2008/0279156 A1
(43) Pub. Date: Nov. 13, 2008

(54) ORTHOGONAL HADAMARD CODE BASED SECONDARY SYNCHRONIZATION CHANNEL

(75) Inventors: Allan Yingming Tsai, Boonton, NJ (US); Guodong Zhang, Farmingdale, NY (US); Kyle Jung-Lin Pan, Smithtown, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/114,013

(22) Filed: May 2, 2008

Related U.S. Application Data
(60) Provisional application No. 60/916,315, filed on May 7, 2007.
(60) Provisional application No. 60/944,593, filed on Jun. 18, 2007.

(51) Int. Cl. H04B 15/00; H04Q 7/20

(52) U.S. Cl. 370/336; 370/328

(57) ABSTRACT

A secondary synchronization channel (S-SCH) for E-UTRA downlink is applied to any orthogonal frequency division multiple access (OFDMA) based system to reduce interference on S-SCHs among sectors of the same Node-B in an evolved universal terrestrial radio access (E-UTRA) system.

### CROSS REFERENCE TO RELATED APPLICATIONS

This application claims the benefit of U.S. Provisional Application No. 60/916,315 filed May 7, 2007 and U.S. Provisional Application No. 60/944,593 filed Jun. 18, 2007, which are incorporated by reference as if fully set forth

### FIELD OF INVENTION

The application is related to wireless communication systems.

### BACKGROUND

To keep the technology competitive for a much longer time period, both Third Generation Partnership Project (3GPP) and 3GPP2 are considering Long Term Evolution (LTE), in which evolution of radio interface and network architecture are necessary.

Orthogonal frequency division multiple access (OFDMA) is adopted for the downlink of Evolved Universal Mobile Telecommunications System (E-UTRA). When a wireless transmit receive unit (WTRU) powers on in the E-UTRA system, it needs to synchronize the frequency, frame timing and the Fast Fourier Transform (FFT) symbol timing with the best cell, and identify the cell identity (ID). This process is called cell search.

By processing the primary synchronization channel (P-SCH), the WTRU acquires at least one of symbol timing, frequency offset and cell group ID. On the other hand, the secondary synchronization channel (S-SCH) provides frame timing, a large number of cell IDs (for example, about 170 cell IDs) and optionally the number of antennas for broadcast channel (BCH).

There are various different structures for S-SCH. Two different S-SCH structures have been proposed in prior art. In FIG. 1, there are two binary sequences S₁ and S₂ that are mapped to two sets of consecutive subcarriers 110 and 120, respectively. In FIG. 2, there are two binary sequences S₁ and S₂ that are mapped to interleaved subcarriers 110 and 120, respectively. The neighboring sectors within a Node B will have inter-cell interference on S-SCHs for the structure in FIG. 1 or structure in FIG. 2, which will degrade the cell search performance.

### SUMMARY

A secondary synchronization channel (S-SCH) for E-UTRA downlink is applied to any orthogonal frequency division multiple access (OFDMA) based system. A method for using a secondary synchronization channel (S-SCH) sequence in an evolved universal terrestrial radio access (E-UTRA) system to avoid or mitigate inter-cell interference on a plurality of S-SCHs, includes, but not limited to: eliminating at least one subcarrier (among central subcarriers used for S-SCH) for DC subcarrier; using orthogonal Hadamard codes as the S-SCHs sequence; masking the orthogonal Hadamard codes by using pseudo-random (PN) codes; and the WTRU detecting orthogonal Hadamard codes.

### BRIEF DESCRIPTION OF THE DRAWINGS

A more detailed understanding of the invention may be had from the following description of a preferred embodiment, given by way of example and to be understood in conjunction with the accompanying drawing(s) wherein:

FIG. 1 shows two sequences mapped to two sets of consecutive subcarriers;

FIG. 2 shows two sequences mapped to interleaved subcarriers;

FIG. 3 shows a cell planning within a cell coverage are for S-SCHs for one embodiment;

FIG. 4 shows a cell planning within a cell coverage are for S-SCHs for another embodiment;

FIG. 5 is a block diagram illustrating a method for using a secondary synchronization channel (S-SCH) sequence; and

FIG. 6 is a functional block diagram of a Wireless Transmit Receive Unit (WTRU) in accordance with the present disclosure.

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

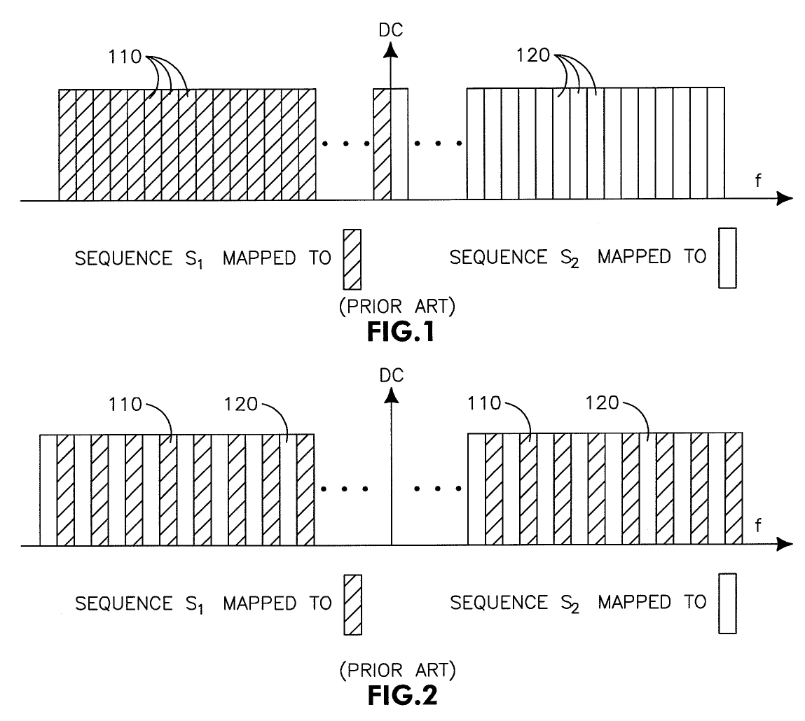

Subsequently described is a method for appropriate S-SCH sequence design for evolved UTRA to avoid or mitigate the inter-cell interference on S-SCHs as described above with respect to FIGS. 1 and 2. There are several possible variations and methods.

Secondary Synchronization Channel (S-SCH)

Hadamard code is used as the S-SCH sequence appropriately to reduce interference on S-SCHs among sectors/cells (of the same Node-B). Suppose both sequences S₁ and S₂ have length of N. Let L denote the length in terms of number of samples of desired duration over which Hadamard codes are still orthogonal after multipath fading, as long as the maximum multipath delay is no larger than L/B. B is the total bandwidth of subcarriers used for sequence S₁ or S₂. N−1 Hadamard codes are divided into L groups. Each group includes G Hadamard codes that are still orthogonal—so that there are no multiple access interference (MAI)—after multipath fading, where L=└N/G┘−1. The orthogonal property of Hadamard codes over delay (according to this formula) is well known in the art, however it is unique here in the invention to use Hadamard codes for S-SCH sequence utilizing their property of orthogonality over limited multipath delay; this will be clear from the examples of the design described hereinafter.

S-SCH Code Construction

Because S-SCH maps to the central 1.25 MHz (corresponds to 75 subcarriers) in the cell bandwidth, then the length of sequences S₁ and S₂ may be chosen as 32. In this case, B=480 KHz. There are several possible sets of parameters for S-SCH design. Two examples below illustrate this design representing different length of L. For convenience, there are only two examples illustrated here within.

A total of 64 central subcarriers are used for S-SCH. Since DC subcarrier is among the 64 central subcarriers, at least one subcarrier of sequence S₁ or sequence S₂ is reserved (or punctured) for DC subcarrier, therefore not used for S-SCH. Hence, the length of sequences S₁ and S₂ are equal to 31 and 32, respectively.

In a first example of the design, choose L=7, and G=4, which means each of the 7 groups has 4 Hadamard codes, denoted as {H₁, H₂, H₃, H₄}, that are still orthogonal after multipath fading as long as the maximum multipath delay is no larger than L/B (7/480 KHz=14.58 μs). Then, different orthogonal Hadamard sequences may be used for sequence S₁ in each sector of the same Node-B. For example, sectors 1, 2, and 3, within a cell, controlled by the same Node B, use H₁, H₂, and H₃ respectively. Similarly, the same method applies to sequence S₂.

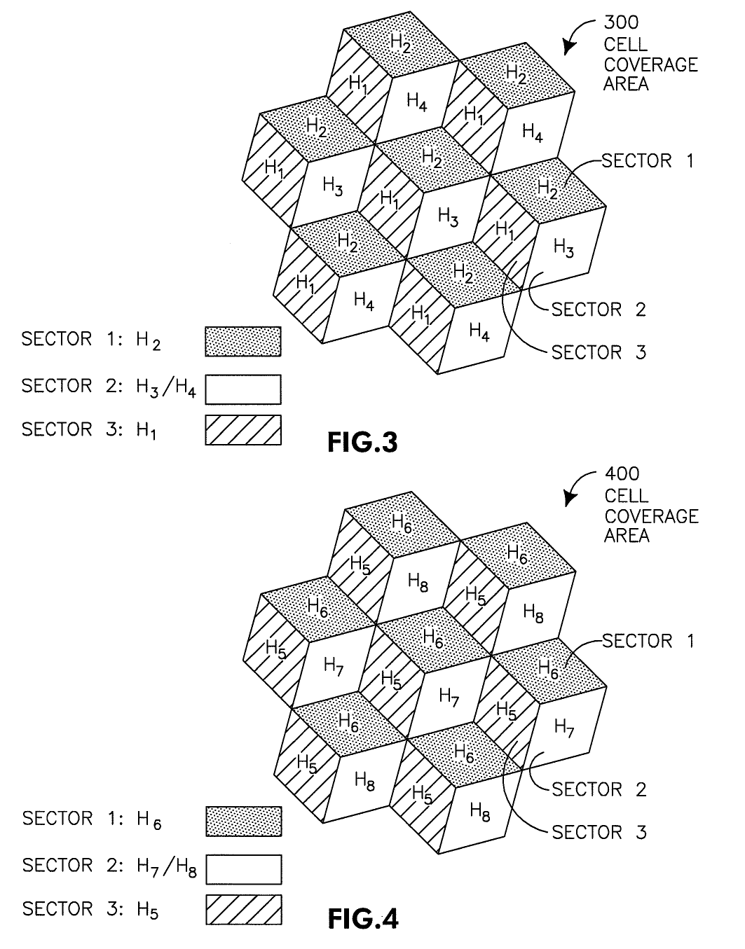

Additionally, in a synchronized network, cell planning is performed among neighboring Node-Bs to mitigate the interference on S-SCHs among sectors of different Node-Bs. To avoid interference, neighboring sectors of different Node-Bs may use different Hadamard codes {H₁, H₂, H₃, H₄} as illustrated in FIG. 3 showing the cell coverage area 300. Also, a scrambling sequence (for example, Golay, PN, or Gold code) is applied to the S-SCH in the frequency domain to mitigate interference among Node-Bs, especially in a non-synchronized network. This example provides larger MAI-free properties for a larger maximum multipath delay than the second example below, therefore being more suitable for large cells.

In the second example of the design, choose L=5 and G=5, which means each of the 5 groups has 5 Hadamard codes, denoted as {H₁, H₂, H₃, H₄, H₅}. In this example, the Hadamard codes are still orthogonal after multipath fading as long as the maximum multipath delay is no larger than L/B (5/480 KHz=10.41 μs). Then, different orthogonal Hadamard sequences may be used for sequence S₁ in each sector of the same Node-B. For example, sectors 1, 2 and 3 use H₁, H₂ and H₃ respectively, as seen in FIG. 3. Similarly, the same method applies to sequence S₂. The difference between the two examples is that the value of L affects maximum multipath delay (L/B) over which the sequence is still orthogonal.

Additionally, in a synchronized network, cell planning is performed among neighboring Node-Bs to mitigate the interference on S-SCHs among sectors of different Node-Bs. To avoid interference, neighboring sectors of different Node-Bs may use different Hadamard codes {H₁, H₂, H₃, H₄, H₅}. Optionally, a scrambling sequence may be applied to the S-SCH in the frequency domain to mitigate interference among Node-Bs, especially in a non-synchronized network. This example (L=5) provides more orthogonal codes, therefore making cell planning in synchronized network easier.

Orthogonal Hadamard Code Groups

Hadamard codes are used as the mother code to generate S-SCH sequence. Number of Hadamard codes are denoted by N (for example, 32) as {H₁, H₂, . . . , H_{N}}. They may be divided into N_{H} groups and each group consists of G Hadamard codes that are still orthogonal (i.e., no multiple access interference) after multipath fading. The value of N_{H} needs to meet two conditions: N_{H}=2^{m} and N_{H}≧L.

Because 64 subcarriers are used the S-SCH is mapped to the central 1.25 MHz (75 subcarriers), then we have B=480 KHz. One of the examples described above a set of parameters for S-SCH design. Here, Let L=5, then N_{H}=8 (i.e., 2³), which means each of the 8 code groups has 4 Hadamard codes that are still orthogonal after multipath fading as long as the maximum multipath delay is no larger than L/B (5/480 KHz=10.41 μs). For sequence S₂, the 8 code groups are C₁={H₁, H₂, H₃, H₄}, C₂={H₅, H₆, H₇, H₈} and so on. For sequences S₁, its code groups are the same as those of sequence S₂, except C₁ is punctured to be {H₂, H₃, H₄}.

Orthogonal Hadamard Code Masked by PN Code

Choose one code group Cᵢ, where i may not equal to the value one because when C₁ is punctured we lose the Hadamard code H₁. Use pseudo-random (PN) codes, K, to mask each Hadamard code in the code group Cᵢ. Then, K×G different sequences are used for sequences S₁ and S₂ in each sector of the same Node-B. Out of the K×G different sequences, there are G orthogonal sequences. Sectors controlled by the same Node-B uses different sequences obtained by masking different Hadamard mother codes.

Here, a typical PN code or M-sequence is used to mask Hadamard codes. However, this is not limited to M-sequence. For example, for the case N=32, L=5 and N_{H}=8, choose K=4. Hence, 16 different sequences may be used. Sequence S₁ uses 13 out of the 16 sequences and sequence S₂ uses 14 out of the 16 sequences. So that, the number of hypotheses supported is 13×14=182. This number is greater than 170; therefore, it meets the S-SCH design requirement.

Cell Planning on S-SCH

Additionally, in a synchronized network, cell planning may be performed among neighboring Node-Bs to mitigate the interference on S-SCHs among sectors of different Node-Bs. In cell planning on S-SCH, adjacent or neighboring sectors or cells use different S-SCH codes that are still orthogonal after multipath delay. Neighboring sectors of different Node-Bs may use sequences with different Hadamard codes as mother codes to avoid interference. An example of these practice is found in a cell coverage (400) is illustrated in FIG. 4. Assuming that C₂={H₅, H₆, H₇, H₈} is used as the mother code, if a sector uses any sequence obtained by masking H₅, then its neighboring sectors may use any sequence obtained by masking H₆, H₇ or H₈, as shown in FIG. 4. In this way, any sequence obtained by masking H₅ is orthogonal to any sequence obtained by masking H₆, H₇ or H₈, over limited multipath delay, therefore intercell interference on S-SCH is reduced.

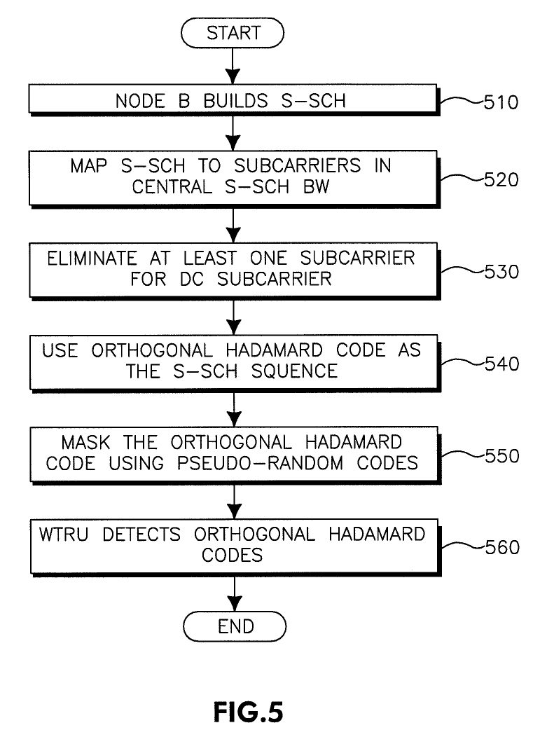

FIG. 5 is a flow diagram of a method using a secondary synchronization channel (S-SCH) sequence in an evolved universal terrestrial radio access (E-UTRA) system to avoid or mitigate inter-cell interference on a plurality of S-SCHs. In an example of this method an eNodeB builds the S-SCH structure (510). There are total of 64 central subcarriers that are used for the S-SCH. These subcarriers are mapped to subcarriers in central S-SCH bandwidth (520). Because the subcarrier include a DC subcarrier at least one subcarrier is reserved (or punctured) for the DC subcarrier (530) making the length of sequences S₁ and S₂ equal to 31 and 32, respectively. Orthogonal Hadamard codes are used as the S-SCH sequence (540). These orthogonal Hadamard codes are masked using pseudo-random codes (550) using mother codes to avoid or mitigate inter-cell interference on a plurality of S-SCHs. The WTRU then receives and detects the orthogonal Hadamard codes (560).

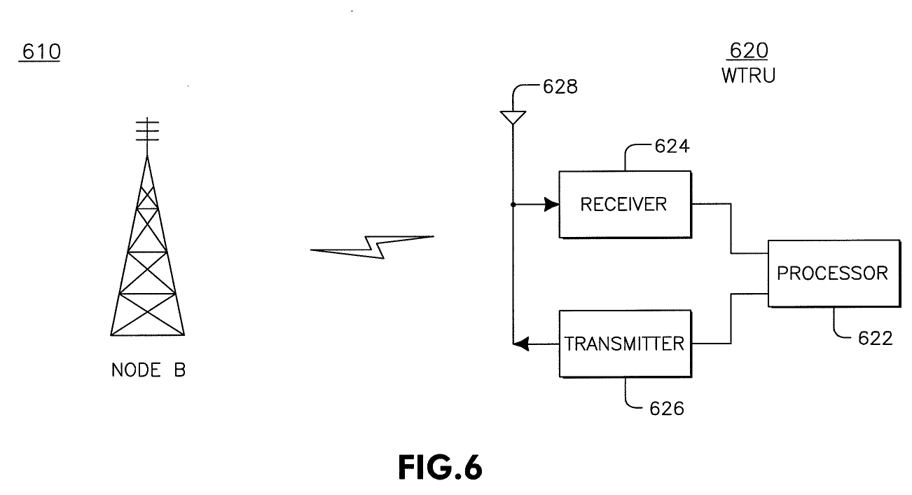

FIG. 6 is a diagram of a WTRU 620 configured to perform the method disclosed here within. In addition to components included in a typical WTRU, the WTRU 620 includes a processor 622 configured to perform the disclosed method, a receiver 624, which is in communication with the processor 622, a transmitter 626, which is in communication with the processor 622, an antenna 628 which is in communication with the receiver 624 and the transmitter 626 to facilitate the transmission and reception of wireless data. The WTRU wirelessly communicates with a base station 610.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for wireless transmit receive unit (WTRU), the method comprising:
receiving orthogonal Hadamard codes; and
detecting the orthogonal Hadamard codes to at least mitigate inter-cell interference on a plurality of secondary synchronization channels (S-SCHs).

2. A wireless transmit receive unit (WTRU) comprising:
a processor, the processor configured to receive orthogonal Hadamard codes and detect the orthogonal Hadamard codes to at least mitigate inter-cell interference on a plurality of secondary synchronization channels (S-SCHs).

3. A method implemented in a base station (bs) for using a secondary synchronization channel (S-SCH) sequence to avoid or mitigate inter-cell interference on a plurality of S-SCHs, the method comprising:
mapping the S-SCH to subcarriers in central S-SCH bandwidth;
reserving at least one subcarrier for DC subcarrier;
using orthogonal Hadamard codes as a S-SCH sequence; and
masking the orthogonal Hadamard codes by using pseudo-random (PN) codes.

4. The method as in claim 3, wherein the orthogonal Hadamard codes are divided into several Hadamard groups, which consist of Hadamard codes that are orthogonal to each other after multipath fading.

5. The method as in claim 3, further comprising cell planning on the S-SCH in a synchronized network to mitigate the interference on the S-SCHs among sectors of different Node-Bs.

6. The method as in claim 5, wherein the sectors of different Node-Bs that are neighbors use sequences with different Hadamard codes.

7. The method as in claim 3, wherein the Hadamard codes are mother codes.

8. A base station (bs) comprising: a processor configured to map the secondary synchronization channel (S-SCH) to subcarriers in central S-SCH bandwidth, to reserve at least one subcarrier for DC subcarrier, to use orthogonal Hadamard codes as a S-SCH sequence; and to mask the orthogonal Hadamard codes by using pseudo-random (PN) codes; and a transmitter configured to transmit the orthogonal Hadamard codes to a wireless transmit receive unit (WTRU).

9. The bs as in claim 8, wherein the processor configured to divide the orthogonal Hadamard codes into several Hadamard groups, which consist of Hadamard codes that are orthogonal to each other after multipath fading.

10. The bs as in claim 8, further comprising cell planning on the S-SCH in a synchronized network to mitigate the interference on the S-SCHs among sectors of different Node-Bs.

11. The bs as in claim 10, wherein the sectors of different Node-Bs that are neighbors use sequences with different Hadamard codes.

12. The bs as in claim 8, wherein the Hadamard codes are mother codes.
